(19) United States
(12) Patent Application Publication
(10) Pub. No.: US 2003/0195010 A1
(43) Pub. Date: Oct. 16, 2003

(54) Emulating a wireless communication device using a local link

(76) Inventors: Ganesh Pattabiraman, Stanford, CA (US); Farrokh Khatibi, San Diego, CA (US); Ranganathan Krishnan, San Diego, CA (US); John W. Nasielski, San Diego, CA (US)

Correspondence Address: Qualcomm Incorporated, Patents Department, 5775 Morehouse Drive, San Diego, CA, 92121-1714, US

(21) Appl. No.: 10/123,621

(22) Filed: Apr. 15, 2002

(51) Int. Cl. H04B 7/00

(52) U.S. Cl. 455/517; 455/450; 455/509

(57) ABSTRACT

Techniques for emulating a first wireless communication device on a wide area network with a second wireless communication device utilizing a local link are disclosed. In one aspect, a first wireless communication device transmits identity information to the second wireless communication device over the local link. The second wireless communication device accesses a wide area network using the identity information received. In another aspect, a first wireless communication device signals a second wireless communication device to emulate the first and access the wide area network. In yet another aspect, the local link is a wireless local link. These aspects have benefits including facilitating emulation of a wireless communication device without exchanging a removable identity module, allowing use of the identity, phone number, or service contract of the first device, and availing the features and systems supported by the second device.

### Related Co-Pending Application

The present Application for Patent is related to co-pending U.S. Application for Patent entitled “SYNCHRONIZATION OF AN EMULATED DEVICE OVER A LOCAL LINK,” by Pattabiraman et al., having Attorney Docket No. 020138, filed concurrently herewith and assigned to the assignee hereof.

### BACKGROUND

1. Field

The present invention relates generally to communications, and more specifically to a novel and improved method and apparatus for emulating a wireless communication device on a wide area network using information exchanged on a local link.

2. Background

Wireless communication systems are widely deployed to provide various types of communication such as voice and data. These systems may be based on code division multiple access (CDMA), time division multiple access (TDMA), or some other modulation techniques. A CDMA system provides certain advantages over other types of systems, including increased system capacity.

A CDMA system may be designed to support one or more CDMA standards such as (1) the “TIA/EIA-95-B Mobile Station-Base Station Compatibility Standard for Dual-Mode Wideband Spread Spectrum Cellular System” (the IS-95 standard), (2) the standard offered by a consortium named “3rd Generation Partnership Project” (3GPP) and embodied in a set of documents including Document Nos. 3G TS 25.211, 3G TS 25.212, 3G TS 25.213, and 3G TS 25.214 (the W-CDMA standard), (3) the standard offered by a consortium named “3rd Generation Partnership Project 2” (3GPP2) and embodied in a set of documents including “C.S0002-A Physical Layer Standard for cdma2000 Spread Spectrum Systems,” the “C.S0005-A Upper Layer (Layer 3) Signaling Standard for cdma2000 Spread Spectrum Systems,” and the “C.S0024 cdma2000 High Rate Packet Data Air Interface Specification” (the cdma2000 standard), (4) the “TIA/EIA-IS-856 CDMA2000 High Rate Packet Data Air Interface Specification” (the IS-856 standard), and (5) some other standards. Non-CDMA systems include AMPS, GSM, and other TDMA systems. These and other wireless communication standards support data communication at various data rates.

Users of wireless communication devices conforming to one or more communication standards, such as those just described, often travel to areas covered by various alternate communication standards. The communication standard provided in any particular geographic region may or may not be supported by the user's device.

In addition, a user may have multiple wireless communication devices, such as a handheld mobile telephone, a mobile telephone in an automobile, or a notebook computer equipped with a mobile telephone for voice and/or data access, whether embedded in the computer or attached with a PC card.

A cellular network is an example of a wide area network. In addition, a cellular network likely connects to the Public Switched Telephone Network (PSTN), as well as other wide area networks, such as the Internet or corporate intranets.

Users may wish to access multiple wide area networks, perhaps using multiple devices, while maintaining a common identity for billing, record keeping, authentication, etc. Removable identity cards allow a user to access a wide area network with a variety of devices, while operating under an existing service contract associated with the identification information on the device. This process is referred to as emulation. For example, a user has a given service contract on device A. The user desires to access a network not available from device A directly, but available from device B. The user provides identification information from device A to device B. Device B then proceeds to access the network using the identification information from device A. In this case, device A is the “emulated device” and device B is the “emulating device.” Methods for providing information from one device to another include R-UIM cards, defined in TIA/EIA/IS-820, “Removable User Identity Module (R-UIM) for TIA/EIA Spread Spectrum Standards”, and SIM cards, defined in GSM 11.11, “Specification of the Subscriber Identity Module”. The user must swap the card between different devices to perform such emulation.

Local wireless communications standards, such as the BLUETOOTH Specification, allow multiple devices to communicate when in proximity to each other, in a peer-to-peer configuration (one of the devices is generally designated the server, and one or more proximate devices act as clients). BLUETOOTH is a trademark owned by BLUETOOTH SIG, Inc. having principle address c/o Sonnenschein Nath & Rosenthal, 1301 K St. NW, Suite 600, East Tower, Washington D.C. 20009. While one example of a wireless local link methodology is described by the BLUETOOTH Specification, other wireless and wired formats may be used to link together two wireless communication devices.

While R-UIM cards, and similar devices, allow one mobile telephone to emulate another, the user must physically swap the device. Local link technology, such as that specified by the BLUETOOTH Specification, is becoming more prevalent. There is therefore a need in the art for emulating a first wireless communication device on a wide area network with a second wireless communication device utilizing a local link.

### SUMMARY

Embodiments disclosed herein address the need for emulating a first wireless communication device on a wide area network with a second wireless communication device utilizing a local link. In one aspect, a first wireless communication device transmits identity information to the second wireless communication device over the local link. The second wireless communication device accesses a wide area network using the identity information received. In another aspect, a first wireless communication device signals a second wireless communication device to emulate the first and access the wide area network. The voice or data communication is then transferred between the wide area network and the first wireless communication device over the local link. In yet another aspect, the local link is a wireless local link. These aspects have benefits including facilitating emulation of a wireless communication device without exchanging a removable identity module, allowing use of the identity, phone number, or service contract of the first device, and availing the features and systems supported by the second device.

The invention provides methods and system elements that implement various aspects, embodiments, and features of the invention, as described in further detail below.

### BRIEF DESCRIPTION OF THE DRAWINGS

The features, nature, and advantages of the present invention will become more apparent from the detailed description set forth below when taken in conjunction with the drawings in which like reference characters identify correspondingly throughout and wherein:

FIG. 1 is a general block diagram of a wireless communication system capable of supporting a number of users;

FIG. 2 depicts a portion of a mobile station equipped for emulation;

FIG. 3 depicts a flowchart of an embodiment of a method for emulating a first wireless communication device with a second device;

FIG. 4 depicts a flowchart of an embodiment of a method for communicating with a first device while emulating that device with a second device on a wide area network; and

FIG. 5 depicts a flowchart of an embodiment of a method for communicating with a second device on a wide area network while emulating a first device.

### DETAILED DESCRIPTION

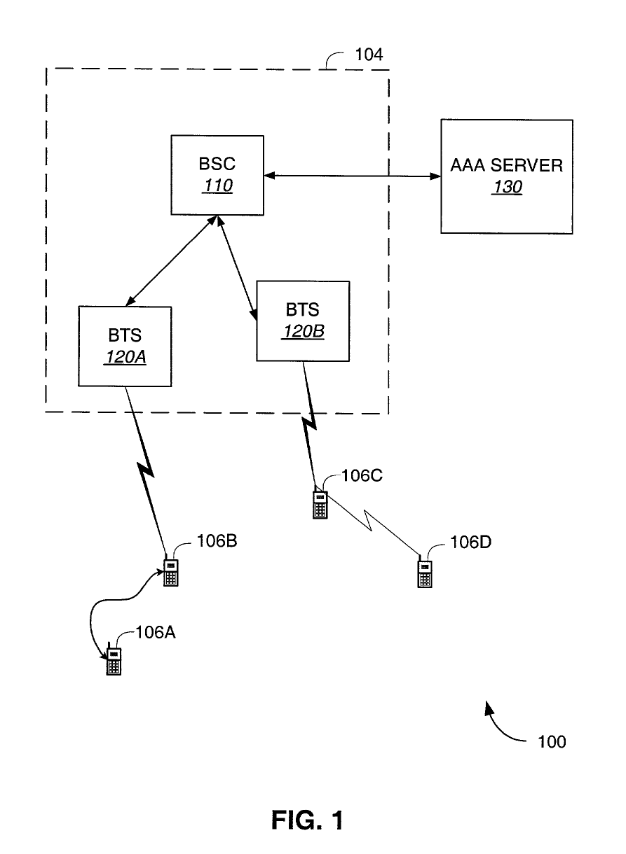

FIG. 1 is a diagram of a wireless communication system 100 that may be designed to support one or more wireless standards and/or designs (e.g., the W-CDMA standard, the IS-95 standard, the cdma2000 standard, the IS-856 standard, GSM, AMPS). Wireless communication system 100 is but one example of a wide area network that may be deployed within the scope of the present invention.

For simplicity, system 100 is shown to include one base station 104 in communication with two mobile stations 106. It is common to find cellular systems including multiple base stations 104. It also common for multiple cellular systems to interact with each other as well as the Public Switched Telephone Network (PSTN) for voice calls, and with one or more Packet Data Service Nodes (PDSNs) for data communications and connectivity with the Internet (details not shown).

The base station and its coverage area are often collectively referred to as a “cell”. In IS-95 systems, a cell may include one or more sectors. In the W-CDMA specification, each sector of a base station and the sector's coverage area is referred to as a cell. As used herein, the term base station may be used interchangeably with the terms access point or Node B. The term mobile station may be used interchangeably with the terms User Equipment (UE), subscriber unit, subscriber station, access terminal, remote terminal, or other corresponding terms known in the art. The term mobile station encompasses fixed wireless applications.

Depending on the system being implemented, each mobile station 106 may communicate with one (or possibly more) base stations 104 on the forward link at any given moment, and may communicate with one or more base stations on the reverse link depending on whether or not the mobile station is in soft handoff. The forward link (i.e., downlink) refers to transmission from the base station to the mobile station, and the reverse link (i.e., uplink) refers to transmission from the mobile station to the base station.

For clarity, the examples used in describing this invention may assume base stations as the originator of signals and mobile stations as receivers and acquirers of those signals, i.e. signals on the forward link. Those skilled in the art will understand that mobile stations as well as base stations may be equipped to transmit data as described herein and the aspects of the present invention apply in those situations as well. The word “exemplary” is used exclusively herein to mean “serving as an example, instance, or illustration.” Any embodiment described herein as “exemplary” is not necessarily to be construed as preferred or advantageous over other embodiments.

Base station 104 comprises a Base Station Controller (BSC) 110 communicating with one or more Base-station Transceiver Subsystems (BTS) 112. A mobile station 106 communicates with one or more BSCs 110 via a wireless connection with one or more BTSs 120. In this example, BSC 110 is connected with BTS 120A and 120B. Mobile station 106B is communicating with BSC 110 via a wireless connection with BTS 120A. Mobile station 106C communicates with BSC 110 through BTS 120B.

Mobile station 106A is connected to mobile station 106B with a wired link. Any of the various wired standards known in the art for connecting devices may be deployed. Mobile station 106A may communicate with base station 104 via its connection to mobile station 106B and the wireless connection between 106B and BTS 120A. Alternatively, mobile station 106B may be used for communication while emulating mobile station 106A using data transferred on the wired link between mobile stations 106A and 106B. These procedures will be described further below.

Similarly, mobile station 106D is connected with mobile station 106C via a wireless link. In the exemplary embodiment, this wireless link is a link supporting the BLUETOOTH Specification, such as version 1.1, but other wireless links may be supported. Mobile station 106D may communicate with base station 104 via its connection to mobile station 106C and the wireless connection between 106C and BTS 120B. Alternatively, mobile station 106C may be used for communication while emulating mobile station 106D using data transferred on the wireless link between mobile stations 106C and 106D. Again, these procedures will be described further below.

The wired or wireless links between two mobile stations 106 are examples of local links which may be used by one mobile station to access a wide area network, such as a cellular system, through another mobile station, or for one mobile station to emulate another mobile station while accessing the wide area network. The mobile stations 106 used for accessing the wide area network will support at least the standard used by base station 104, and may support a variety of other standards. In the example of FIG. 1, mobile stations 106B and 106C support the communication standard deployed by base station 104. Mobile stations 106A and 106D may or may not support the communication standard deployed in base station 104.

For example, mobile station 106C may be a car phone owned by a user. The user may also own a handheld mobile phone 106D. The user may want the handheld mobile phone 106D to connect with the car phone 106C, so that certain features of the car phone, such as handsfree operation or support for a desired data capability are available while driving, and yet the phone number and service contract of the handheld mobile phone 106D allow others to reach the user and dictate the terms of service, respectively. In the exemplary embodiment, the local link between mobile stations 106C and 106D is a link supporting the BLUETOOTH Specification, such as version 1.1, so the two mobile stations must merely come in proximity to each other. The user needn't connect any wires or transfer any components, such as an R-UIM card. In this example, both mobile phones 106C and 106D may be capable of communicating with base station 104, yet the user has reason to connect with the wide area network, that is, cellular system 100, with mobile station 106C.

As another example, mobile station 106D may not support the communication standard deployed by base station 104. The user of 106D may have traveled to a region with an incompatible cellular network, for example. That user may rent a mobile phone 106C that does operate on cellular network 100. The user may then access system 100 with the rented phone 106C while remaining accessible at the phone number assigned to mobile station 106D and operating under the user's existing service contract. As before, the two mobile stations need only come within a certain distance to connect a link supporting the BLUETOOTH Specification or other wireless link.

Wireless connections between various base stations 104 and mobile stations 106 are established using an Authentication, Authorization, and Accounting (AAA) server 130. AAA server 130 authorizes a mobile station 106 by verifying that the mobile station identification corresponds to a valid subscriber. In addition, various parameters associated with an authorized subscriber may be returned to a network, such as terms of service, features supported, roaming capabilities, and the like. In a typical cellular system, a subscriber is authenticated using an authentication protocol with a shared secret, password, or key corresponding to the subscriber information stored in AAA server 130. A variety of authentication protocols are known in the art, and any such scheme may be deployed within the scope of the present invention.

Although a single AAA server 130 is shown, those of skill in the art will recognize that AAA server 130 may represent a network of AAA servers and/or proxy AAA servers. An AAA server 130 in one network may receive a request for authentication of a mobile station that is not known by that AAA server. The AAA server may access one or more additional servers with the request, until the AAA server containing the information corresponding to the mobile station is found.

Those of skill in the art will recognize that an AAA server deployed for authorization of a mobile station is exemplary only. Some IS-2000 packet services use an AAA server, as does IS-856. Other systems, such as IS-95 and IS-2000 systems, use a Home Location Register/Authentication Center (HLR/AC) for authentication, authorization, and to support roaming information/service profile download. The term AAA server, as used herein, may be used interchangeably with HLR/AC, as well as any other device for providing authentication, authorization, service profile, and similar services.

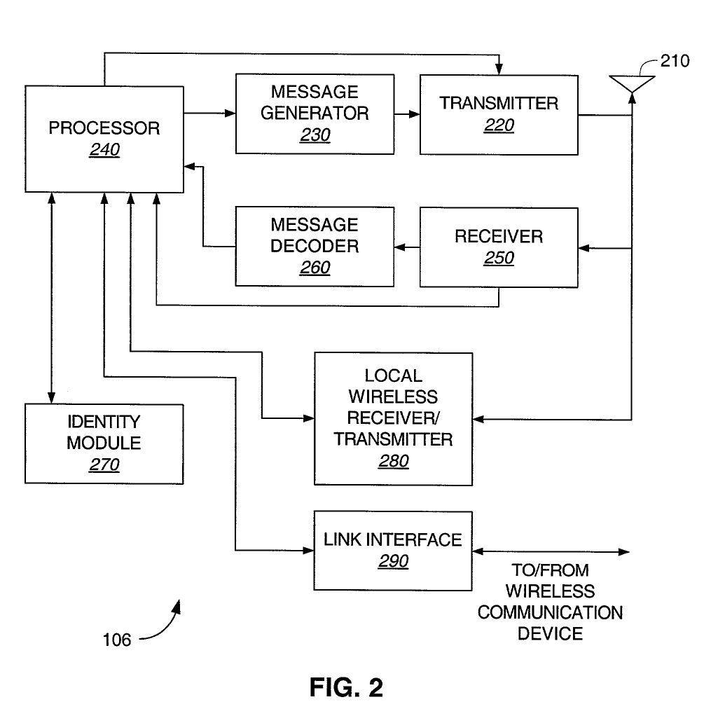

FIG. 2 depicts a portion of a mobile station 106. Signals are received with antenna 210 and delivered to receiver 250. Receiver 250 performs processing according to one or more wireless system standards, such as the cellular standards listed above. Receiver 250 performs various processing such as Radio Frequency (RF) to baseband conversion, amplification, analog to digital conversion, filtering, demodulation, deinterleaving, decoding, and the like. Various techniques for receiving are known in the art. Data received may be transmitted to processor 240 for use in voice or data communications. Additional components for supporting voice communications or data applications are not shown.

Received data is also delivered to message decoder 260. Message decoder 260 decodes various messages used in setting up, maintaining and tearing down a call on a cellular network (or other wide area network). Various call setup procedures and their related messages are known in the art. Examples include paging messages from base station 104, or messages responding to access request messages from mobile station 106. Authentication procedures, involving both base station 104 and AAA server 130 may produce messages for delivery to mobile station 106 and subsequent decoding in message decoder 260. The various messages are delivered to processor 240. Those of skill in the art will recognize that some or all of the procedures carried out in message decoder 260 and/or receiver 250 may be performed in processor 240.

Processor 240 directs message generator 230 to generate various messages used in setting up, maintaining and tearing down a call on a cellular network (or other wide area network). Various call setup procedures and their related messages are known in the art. Examples include access requests to base station 104, or messages responding to paging messages from base station 104. Authentication procedures, involving both base station 104 and AAA server 130 may require response messages for delivery to base station 104. In addition, a mobile station may send messages to register with a base station and remain in an idle state until a call is received or initiated.

The messages are delivered to transmitter 220 for formatting according to one or more communication standards supported by mobile station 106. Procedures in transmitter 220 may include vocoding, encoding, interleaving, modulation, filtering, amplification, digital to analog conversion, modulation, and the like. In addition, data for use in voice communication or a data application may be delivered to transmitter 220 from processor 240. Signals generated in transmitter 220 are delivered for transmission on antenna 210. Those of skill in the art will recognize that some or all of the procedures carried out in message generator 230 and/or transmitter 220 may be performed in processor 240.

Some mobile stations 106 may include a local wireless receiver/transmitter 280 for receiving and transmitting data on a local wireless link. In the exemplary embodiment, local wireless receiver/transmitter 280 transmits and receives formatted data consistent with the BLUETOOTH Specification. As shown in FIG. 2, local wireless receiver/transmitter 280 shares antenna 210. Alternate embodiments may deploy a second antenna for use by local wireless receiver/transmitter 280. Two mobile stations 106, each equipped with a local wireless receiver/transmitter 280, may establish a local wireless link such as that described between mobile stations 106C and 106D in FIG. 1. Note that the communication standards supported by transmitter 220, receiver 250, message generator 230, and message decoder 260, described above, need not be identical or overlapping between two mobile stations 106. In some situations, described above, a first mobile station 106 may utilize the wireless link processed with local wireless receiver/transmitter 280 to access a cellular or other wide area network via a second mobile station 106, wherein the network would not be accessible using standards supported by the first mobile station 106. Local wireless receiver/transmitter 280 connects with processor 240 for processing the local wireless link.

In addition to or in lieu of local wireless receiver/transmitter 280, a mobile station 106 may include a link interface 290 for wired connection with another wireless communication device, such as another mobile station 106. The wired connection may be used in similar fashion as just described with respect to the local wireless communication link. Link interface 290 connects with processor 240 for processing the local wired link.

Processor 240 may be a general purpose microprocessor, a Digital Signal Processor (DSP), or a special purpose processor. Processor 240 may perform some or all of the functions of message generator 230, transmitter 220, message decoder 260, receiver 250, local wireless receiver/transmitter 280, or link interface 290, and may be connected with special purpose hardware to assist in these tasks (details not shown). Data or voice applications may be external to mobile station 106, such as an externally connected laptop computer, may run on an additional processor within mobile station 106 (not shown), or may run on processor 240 itself. Processor 240 may have embedded memory, or be connected to a memory (not shown) for storing instructions to perform various procedures and methods, detailed further below.

A mobile station 106 may include an identity module 270 for storing identity and authentication information (such as passwords, shared secret information, and the like). The identity information may be accessed and incorporated in various messages generated or received for registration, authentication, call setup, and the like. The identity module 270 may be part of processor 240, or incorporated in non-volatile memory attached thereto (not shown). In some cases both mobile stations 106 communicating over a local link, such as 106C and 106D, or 106A and 106B, shown in FIG. 1, will also support removable identity modules, such as an R-UIM interface. The local link, use of which is described in further detail below, may be used to alleviate the requirement of physically moving the R-UIM card from one mobile station to another. Note that the identity information stored in any of the mobile stations 106 need not be in a removable module.

Various mobile stations 106, such as those shown in FIG. 1, need not be configured with identical sets of components. For example, some mobile stations may be equipped for local wireless links only, or local wired links only, or both. As stated above, the set of supported standards for communicating on a wide area network 100, such as a cellular network, may be unique for each mobile station 106. One useful configuration includes a first mobile station 106 connecting with a second mobile station 106 with a wired or wireless local link to access a wide area network using a communication standard not supported by the first mobile station 106.

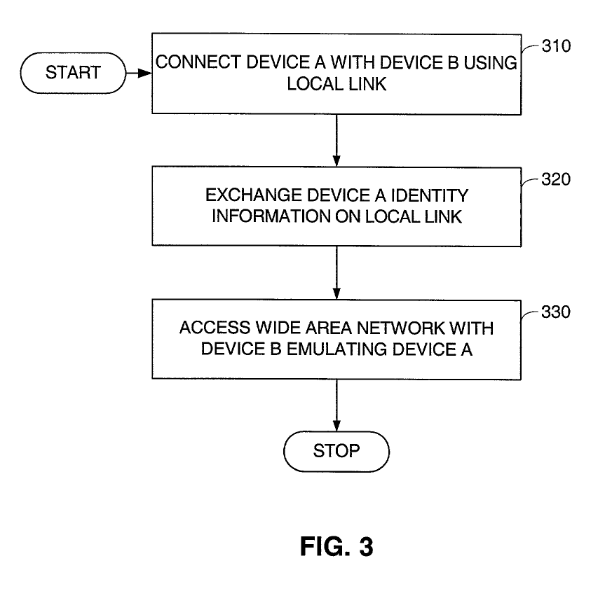

FIG. 3 depicts a flowchart of an embodiment of a method for emulating a first wireless communication device with a second. The wireless communication devices 106 shown in FIG. 1 and further detailed in FIG. 2 are examples. The process begins in step 310, where the first device, referred to as device A, is connected with the second device, referred to as device B, using a local link such as those described above. As used herein device A is the “emulated device,” and device B is the “emulating device.” In the exemplary embodiment, a wireless local link such as one supporting the BLUETOOTH Specification is deployed. Any of a variety of local links, wired or wireless, may be deployed in alternate embodiments. A local wireless receiver/transmitter 280, described above, may be used in both device A and device B to communicate if a wireless local link is deployed. A link interface 290, described above, may be used in both device A and device B to communicate if a wired local link is deployed.

In this example, when emulation is performed, device B will be used to access the wide area network. In the exemplary embodiment, the wide area network includes a wireless communication system such as the cellular systems described above. Proceed to step 320.

In step 320, identity information for device A, the device to be emulated, is exchanged between device A and device B on the local link. An identity module 270 may be deployed in device A for storing the identity information, to be accessed for transmission to device B during emulation, or for use in call setup by device A when emulation is not desired (this alternative is detailed further below). In the exemplary embodiment, identity module 270 is an R-UIM card. Proceed to step 330.

In step 330, device B accesses the wide area network using the identity information from device A, transferred on the local link in step 320. Various procedures for call setup according to various communication standards are known in the art, as well as registration, authentication, and similar procedures used in accessing a cellular system and/or wide area network. Messages for performing these procedures may be generated and decoded in a message generator 230 and a message decoder 260, respectively, deployed in device B. (Device A may be similarly equipped, but the wide area network is accessed through the components of device B when device A is being emulated.) Note that steps 320 and 330 may occur simultaneously. Note further that identity information may be accessed a number of times during authentication and call setup. The identity information exchange step may be performed once initially, with all required information stored on device B, for access as required. Alternatively, identity information may be retrieved in one or more accesses using the local link established in step 310. Once the wide area network has been accessed and a communication link has been successfully set up, voice or data communications may proceed between device B and the wide area network, utilizing the identity and associated service contract features of device A, while using device B and its capabilities for communication with the wide area network. The emulation of device A in step 330 may stop once the voice or data application terminates, or it may remain in place while numerous calls are initiated or received, terminating at the user's request. Device B may emulate device A in an idle mode, waiting for the user to initiate a voice or data call, or for a call directed to device A to be received.

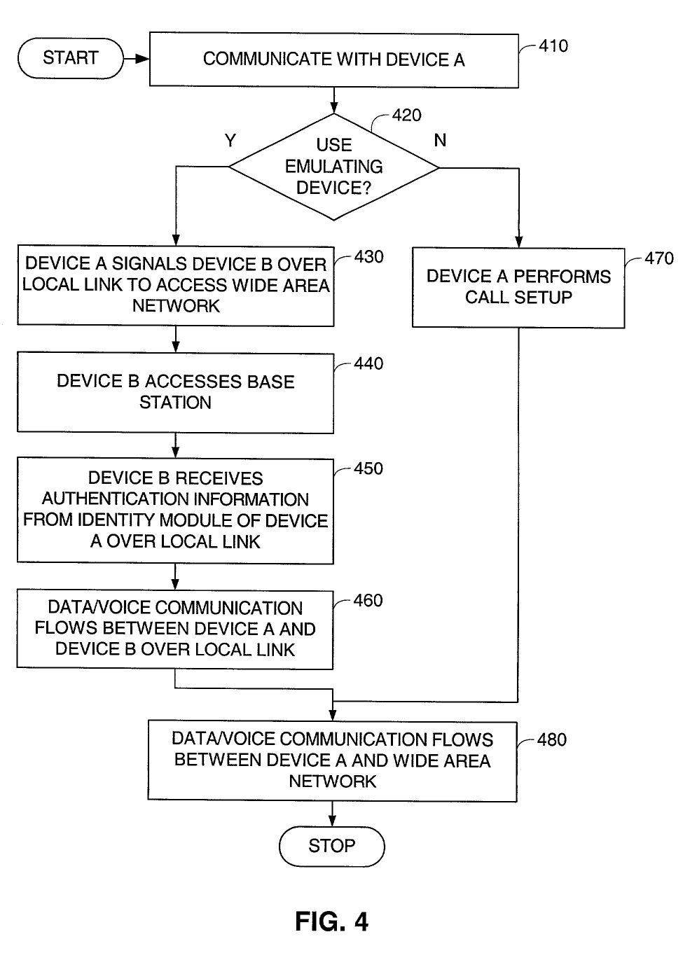

A user, equipped with both devices A and B, may make a determination to use either device as the access terminal. For example, a laptop computer equipped with a cellular PC card, device A, may establish a wireless local link with a mobile station in an automobile, device B. The impetus for such a connection may be that the automobile's mobile station supports the cellular system in the geographical area while the PC card in the notebook computer supports only other cellular systems. Or, the automobile's mobile station provides the benefits of a larger supply of power, or supports higher data rates. In situations such as these, device A is acting as the access terminal. For example, a data application may be running on the notebook computer, or device A, and so device A may direct device B, the mobile station in the automobile, to access the network, emulate device A, and transfer communication data across the local link to device A. Or, a user may prefer to talk using one handheld mobile telephone, device A, because it has certain features, such as programmed contact lists, that the user would like to use. A rented mobile telephone, device B, provides network access due to its support of the cellular system provided in the geographical area. Thus, device A is the access terminal and device B acts as a conduit in the connection between device A and the wide area network. An embodiment of a method for communicating with device A while emulating device A with device B on a wide area network is described below with respect to FIG. 4.

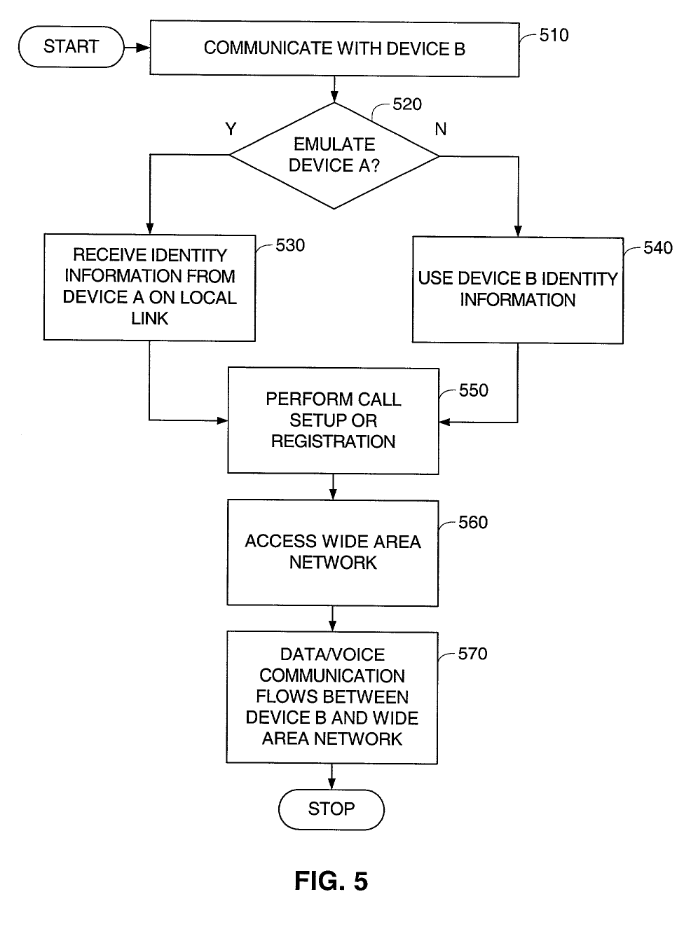

Alternatively, there may be situations where device B, the emulating device, is to be the access terminal. For example, if a user brings a handheld mobile telephone, device A, into an automobile equipped with a mobile station, device B, the user may wish to use the automobile's mobile station for communication. It may be that device B is equipped with a handsfree system that makes conversing on device B preferable while driving. Or, in contrast to the example of two handheld mobile telephones described above, the user may elect to talk using device B rather than device A. An embodiment of a method for communicating with device B on a wide area network while emulating device A is described below with respect to FIG. 5.

FIG. 4 depicts an embodiment of a method for communicating with device A while emulating it with device B on a wide area network. This method is applicable where device A is to act as the access terminal, as described above. The process starts in step 410, where it is determined to communicate with device A, for any reason, including those examples given earlier. Proceed to decision block 420.

In decision block 420, if an emulating device, that is, device B, is to be used, proceed to step 430. If not, then proceed to step 470. In step 470, device A performs call setup with the wide area network, and the process proceeds to step 480 where data or voice communication flows between device A and the wide area network.

In step 430, device A signals device B over a local link, such as those described above, to access the wide area network. Proceed to step 440. In step 440, device B accesses a base station supporting the communication standard provided in the geographical region. The access may be for a voice or data connection, or simply to register with the wide area network. (Alternatively, the link may remain idle until device A initiates a call or a call directed to device A is received at device B.) A variety of call setup and registration procedures for various communication standards, examples of which are given above, are known in the art. Proceed to step 450. In step 450, device B receives authentication information, or any other information required for emulation, from the identity module of device A over the local link. Steps 440 and 450 may occur in parallel, and information from device A may be accessed in one step or in segments during call setup or registration. Proceed to step 460. In step 460, data or voice communication flows between device A and device B over the local link. If device B was the access terminal, then only the identity and/or authentication information would be transferred over the local link, and the voice or data communication would terminate at device B. In this case, the local link is used to transfer traffic data between device A and B as well. Proceed to step 480, where data and voice communication flows between device A and the wide area network, using the link between device B and the wide area network and the local link between device A and device B. The process may terminate when the voice or data call terminates, or may repeat for numerous received or initiated calls or data sessions.

FIG. 5 depicts an embodiment of a method for communicating with device B on a wide area network while emulating device A. This method is applicable where device B is to act as the access terminal, as described above. The process starts in step 510, where it is determined to communicate with device B, for any reason, including those examples given earlier. Proceed to decision block 520.

In decision block 520, if device B is to emulate device A, proceed to step 530. In step 530, receive identity information from device A on a local link. This may be accomplished in a variety of ways, including those examples given above. In decision block 520, if device B is not to emulate device A, proceed to step 540. In step 540, use the device B identity information. This may be stored in an identity module 270 deployed in device B, as described above with respect to FIG. 2. From either step 530 or 540, proceed to step 550.

In step 550, device B performs call setup or registration, using device B identity information or emulating device A using device A identity information. Either step 530 or step 540 may be performed in parallel with step 550. Step 530 identity information may be exchanged at one time, or in segments during call setup or registration in step 550. Proceed to step 560. In step 560, device B accesses the wide area network. As described earlier, this may entail accessing a cellular network solely, or the call set up in step 550 may be connected with the PSTN for a voice call or another wide area network, such as the Internet or a corporate intranet, via a PDSN. Steps 560 and 550 may be combined in a single step, depending on the voice or data application. Proceed to step 570. In step 570, data or voice communication flows between device B and the wide area network. The process may terminate when the voice or data call terminates, or may repeat for numerous received or initiated calls or data sessions.

The techniques described above may also be deployed using multiple clients or multiple servers. For example, a mobile station 106 may be a client on more than one local link, such as a link supporting the BLUETOOTH Specification. The methods described may be deployed to allow the client mobile station, acting as device A, to access one or more wide area networks with a number of servers, acting as device B, where each server connects with the wide area network for a portion of time. Similarly, multiple client mobile stations, each acting as a device A, may be connected to a server, or device B. The clients may essentially time-share access to the wide area network through the server, device B. The clients may coordinate with the server such that the server accesses the wide area network emulating one client at a time. The client information for each emulated client may be transmitted over the local link as appropriate during the time period that the server is emulating a particular client. Those of skill in the art will readily apply the techniques disclosed herein to these multi-client or multi-server applications.

Those of skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor may read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A wireless communication device, operable with a base station included in a wide area network, and operable with a second wireless communication device over a local link, comprising:
a link interface for receiving identity information on the local link from the second wireless communication device; and
a message generator for generating a message directed to the base station for accessing the wide area network, the message including the identity information received.

2. The wireless communication device of claim 1, wherein the link interface operates with a wireless local link.

3. The wireless communication device of claim 1, wherein the link interface operates with a wired local link.

4. A wireless communication device, operable with a second wireless communication device over a local link, comprising:
a link interface for transmitting identity information on the local link to the second wireless communication device.

5. The wireless communication device of claim 4, wherein the link interface operates with a wireless local link.

6. The wireless communication device of claim 4, wherein the link interface operates with a wired local link.

7. The wireless communication device of claim 4, further comprising an identity module for storing identity information.

8. The wireless communication device of claim 7, wherein the identity module is removable.

9. A wireless communication system, comprising:
a base station;
a first wireless communication device; and
a second wireless communication device for receiving identity information over a local link from the first wireless communication device and for accessing the base station with the identity information received.

10. A wide area network, including a wireless communication system, comprising:
a first wireless communication device; and
a second wireless communication device for receiving identity information over a local link from the first wireless communication device and for accessing the wireless communication system with the identity information received.

11. A method of emulating a wireless communication device, comprising:
accessing a wireless communication device over a local link;
receiving identity information over the local link from the wireless communication device; and
accessing a wide area network using the identity information received.

12. A method of emulating a wireless communication device, comprising:
signaling, over a local link, a wireless communication device to access a wide area network;
transmitting identity information to the wireless communication device for use in accessing the wide area network; and
exchanging data with the wide area network over the local link.

13. A method of emulating a wireless communication device, comprising:
accessing a first wireless communication device with a second wireless communication device over a local link;
receiving identity information at the second wireless communication device from the first wireless communication device over the local link; and
accessing a wide area network with the second wireless communication device using the identity information received.

14. A wireless communication device, comprising:
means for accessing a second wireless communication device over a local link;
means for receiving identity information over the local link from the second wireless communication device; and
means for accessing a wide area network using the identity information received.

15. A wireless communication device, comprising:
means for signaling, over a local link, a second wireless communication device to access a wide area network;
means for transmitting identity information to the second wireless communication device for use accessing the wide area network; and
means for exchanging data with the wide area network over the local link.

16. A wireless communication system, comprising:
means for accessing a first wireless communication device with a second wireless communication device over a local link;
means for receiving identity information at the second wireless communication device from the first wireless communication device over the local link; and
means for accessing a wide area network with the second wireless communication device using the identity information received.

17. Processor readable media operable to perform the following steps:
signaling, over a local link, a wireless communication device to access a wide area network;
transmitting identity information to the wireless communication device for use in accessing the wide area network; and
exchanging data with the wide area network over the local link.

18. Processor readable media operable to perform the following steps:
accessing a wireless communication device over a local link;
receiving identity information over the local link from the wireless cation device; and
accessing a wide area network using the identity information received.
